(19) United States
(12) Patent Application Publication
(10) Pub. No.: US 2022/0321558 A1
(43) Pub. Date: Oct. 6, 2022

(54) SECURE DATA TRANSFERS USING BEHAVIOR-BASED AUTHENTICATION

(71) Applicant: Bank of America Corporation, Charlotte, NC (US)

(72) Inventors: Neal Aaron Slensker, Fort Mill, SC (US); Michael Robert Young, Davidson, NC (US); Carmel Marie Blaney, Herndon, VA (US); Geoffrey George Aslaksen, Matthews, NC (US); Jada S. Sifford-Logan, Charlotte, NC (US); Daniel J. August, Denver, NC (US)

(21) Appl. No.: 17/223,317

(22) Filed: Apr. 6, 2021

(51) Int. Cl. H04L 29/06; H04L 9/06; G06F 21/45

(52) U.S. Cl. CPC H04L 63/0861; H04L 63/0876; H04L 9/0643; G06F 21/45; H04L 2209/16

(57) ABSTRACT

A device that is configured to capture biometric information for a user using a first biometric sensor that is configured to capture biometric information that identifies physical characteristics of the user. The device is further configured to capture device information for a user device that is associated with the user. The device is further configured to generate an authentication fingerprint for the user based on a combination of the biometric information and the device information. The device is further configured to obtain vital sign information using a second biometric sensor that is configured to capture vital sign information that identifies a physical state of the user. The device is further configured to generate an authentication request that includes the authentication fingerprint and the vital sign information and to send the authentication request to a network device.

### TECHNICAL FIELD

The present disclosure relates generally to information security, and more specifically to secure data transfers using behavior-based authentication.

### BACKGROUND

In a network environment, devices are in data communication with other devices that may be distributed anywhere in the world. These network environments allow data and information to be shared among devices. One of the technical challenges that occur when data is exchanged between devices is controlling data leakage, unauthorized access to data, and preventing malicious activities. Data storing devices, such as databases and servers, are vulnerable to online attacks. This vulnerability poses several network security challenges. For example, when a bad actor gains unauthorized access to a user's authentication credentials (e.g. a user name and password), the bad actor is then able to perform malicious activities (e.g. data exfiltration or uploading malware) within a network while posing as the user.

### SUMMARY

The system disclosed in the present application provides a technical solution to the technical problems discussed above by providing an authentication system that uses a combination of a static authentication token and a dynamic authentication token to authenticate a user before allowing the user to transmit or receive data over a network. The disclosed system provides several practical applications and technical advantages which include a process for providing enhanced information security by using a static authentication token (i.e. an authentication fingerprint) to authenticate a user based on the unique combination of their physical characteristics and their user device. The authentication system first employs one or more biometric sensors to obtain biometric information (e.g. a fingerprint scan or a retinal scan) for the user. The authentication system then combines the biometric information with device information that is associated with a user's user device to generate an authentication fingerprint. This process allows the authentication system to generate a static authentication token that can be used to authenticate a user based on their known physical characteristics and their user device. This process provides information security because a bad actor will need to obtain both the user's biometric information and their user device information to gain access to the user's authentication fingerprint.

The authentication system also uses the dynamic authentication token (i.e. vital sign information) to authenticate a user based on the current physical state of the user. Examples of the vital sign information include, but are not limited to, a respiration rate, a pulse rate, a blood pressure measurement, a body temperature measurement, or any other suitable type of information that is associated with the current physical state of the user. For example, the vital sign information may comprise information about the breathing rate and/or heart rate of the user when making an authentication request. The authentication system compares the vital sign information to previously stored vital sign information for the user to determine whether the user is under duress when sending an authentication request. This process provides information security by denying the authentication request for a data transfer when the user is under duress. This process protects the user's account and data even if the user provides valid authentication credentials when making the authentication request. A user fails the authentication process when either the static authentication token or the dynamic authentication token fails authentication. The authentication system is further configured to trigger fraud protection services when the user fails authentication. This process provides even further enhanced information security for the user's account and their data.

In one embodiment, the authentication system comprises an authentication device that is configured to receive an authentication request for a user. The authentication request includes a first authentication fingerprint and vital sign information. The authentication device identifies a second authentication fingerprint from a memory that matches the first authentication fingerprint and identifies vital sign information that is associated with the second authentication fingerprint. The authentication device then compares the vital sign information from the authentication request to a tolerance threshold value. The tolerance threshold value identifies a maximum difference or deviation from the vital sign information that is associated with the second authentication fingerprint that is acceptable to pass authentication. The authentication device then generates an authentication response based on the comparison and sends the authentication response to a network device. The authentication response indicates whether the user has passed authentication.

In another embodiment, the authentication system comprises a user device that is configured to capture biometric information for a user using a first biometric sensor. The first biometric sensor is configured to capture biometric information that identifies physical characteristics of the user. The user device also captures user device information that is associated with the user. The user device then generates an authentication fingerprint for the user based on a combination of the biometric information and the device information. The user device is further configured to obtain vital sign information using a second biometric sensor. The second biometric sensor is configured to capture vital sign information that identifies the physical state of the user. The user device then generates an authentication request that includes the authentication fingerprint and the vital sign information and sends the authentication request to a network device.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of an authentication system that is configured to use behavior-based authentication;

FIG. 2 is a flowchart of an embodiment of an authentication process for a user device using behavior-based authentication;

FIG. 3 is a flowchart of an embodiment of an authentication process for an authentication device using behavior-based authentication;

FIG. 4 is an embodiment of a user device configured to use behavior-based authentication; and

FIG. 5 is an embodiment of an authentication device configured to use behavior-based authentication.

### DETAILED DESCRIPTION

### System Overview

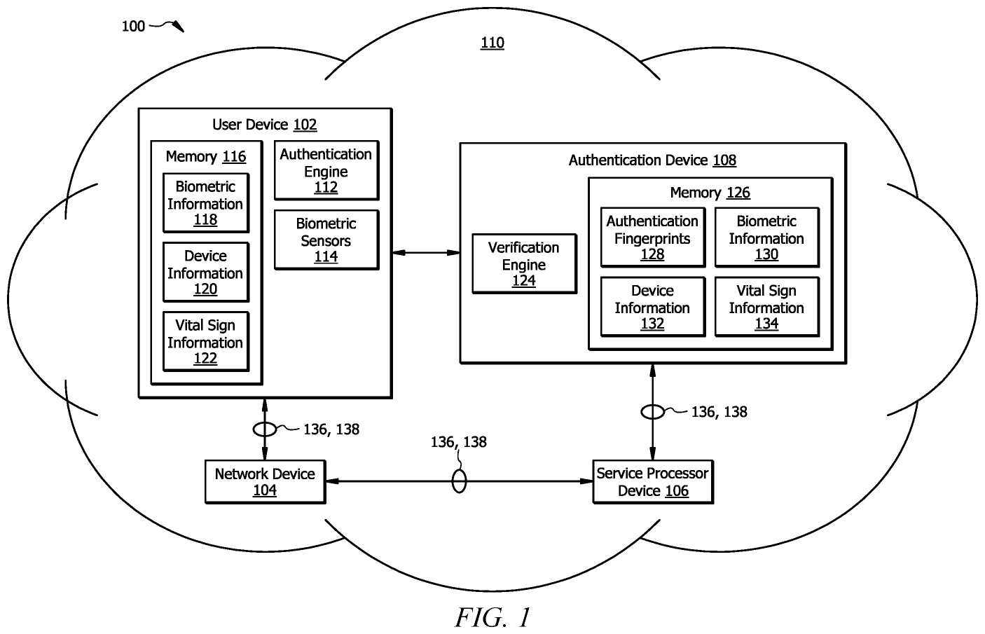

FIG. 1 is a schematic diagram of an embodiment of an authentication system 100 that is configured to use behavior-based authentication. The authentication system 100 is generally configured to authenticate a user using a static authentication token and a dynamic authentication token before allowing the user to transmit or receive data from a network device 104. In a first phase of the authentication process, the authentication system 100 uses the static authentication token (i.e. an authentication fingerprint 128) to authenticate a user based on the unique combination of their physical characteristics and their user device. The authentication system 100 first employs one or more biometric sensors 114 to obtain biometric information 118 (e.g. a fingerprint scan or a retinal scan) for the user. The authentication system 100 then combines the biometric information 118 with device information 120 that is associated with a user's user device 102 to generate an authentication fingerprint 128. This process allows the authentication system 100 to generate a static authentication token that can be used to authenticate a user based on their known physical characteristics and the user device. This process provides information security because a bad actor will need to obtain both the user's biometric information 118 and their user device information 120 to gain access to the user's authentication fingerprint 128. While generating the authentication fingerprint 128, the authentication system 100 may also apply hashing or encryption operations onto the biometric information 118 and the device information 120 to further obfuscate the user's information. This process increases the complexity and difficulty for a bad actor to gain access to a user's authentication fingerprint 128.

In a second phase of the authentication process, the authentication system 100 uses the dynamic authentication token (i.e. vital sign information 122) to authenticate a user based on the current physical state of the user. For example, the vital sign information 122 may comprise information about the breathing rate or heart rate of the user when making an authentication request 136. The authentication system 100 compares the vital sign information 122 to previously-stored vital sign information 134 for the user to determine whether the user is under duress when sending an authentication request 136. This process provides information security by denying the authentication request 136 for a data transfer when the user is under duress. This process protects the user's account and data even if the user provides valid authentication credentials when making the authentication request 136.

In one embodiment, the authentication system 100 comprises a user device 102, a network device 104, a service processor device 106, and an authentication device 108 that are in signal communication with each other over a network 110. The network 110 may be any suitable type of wireless and/or wired network including, but not limited to, all or a portion of the Internet, an Intranet, a private network, a public network, a peer-to-peer network, the public switched telephone network, a cellular network, a local area network (LAN), a metropolitan area network (MAN), a personal area network (PAN), a wide area network (WAN), and a satellite network. The network 110 may be configured to support any suitable type of communication protocol as would be appreciated by one of ordinary skill in the art.

### User Device

Examples of the user device 102 include, but are not limited to, a smartphone, a tablet, a laptop, a computer, or any other suitable type of user device. The user device 102 is generally configured to capture biometric information 118 and device information 120 and to generate an authentication fingerprint 128 based on the biometric information 118 and the device information 120. The authentication fingerprint 128 is a static authentication token that can be used to authenticate a user based on their physical characteristics and the user device. As an example, the authentication fingerprint 128 may be a unique binary bit string that is generated based on the combination of the biometric information 118 and the device information 120.

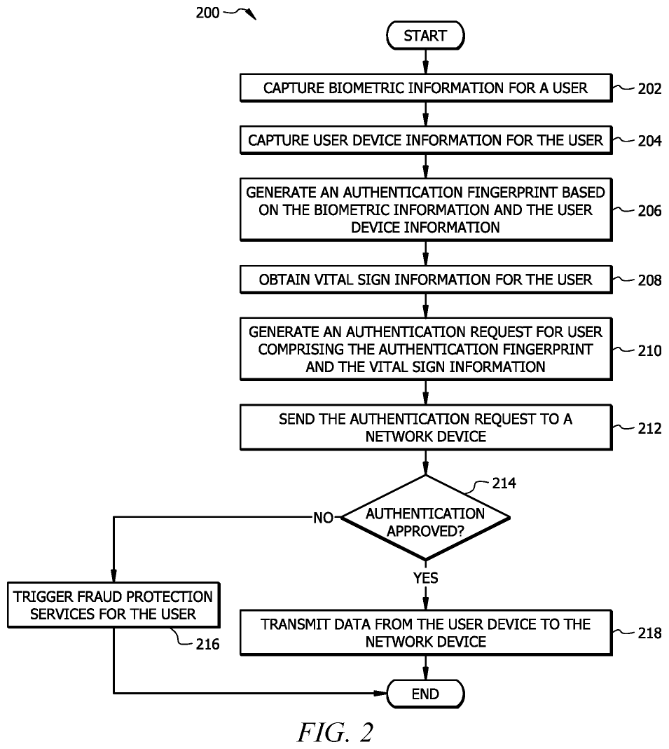

The user device 102 is further configured to obtain vital sign information 122 for the user and to generate an authentication request 136 for the user that includes the vital sign information 122 and the authentication fingerprint 128. In this configuration, the authentication request 136 comprises a static authentication token (i.e. an authentication fingerprint 128) and a dynamic authentication token (i.e. the vital sign information 122) that can be used to authenticate the identity of a user. In some embodiments, the authentication request 136 may further comprise one or more user inputs. Examples of user inputs include, but are not limited to, authentication credentials, a user password, a temporary token, a personal identification number (PIN) code, a device identifier, or any other suitable type of information. An example of the user device 102 in operation is described below in FIG. 2.

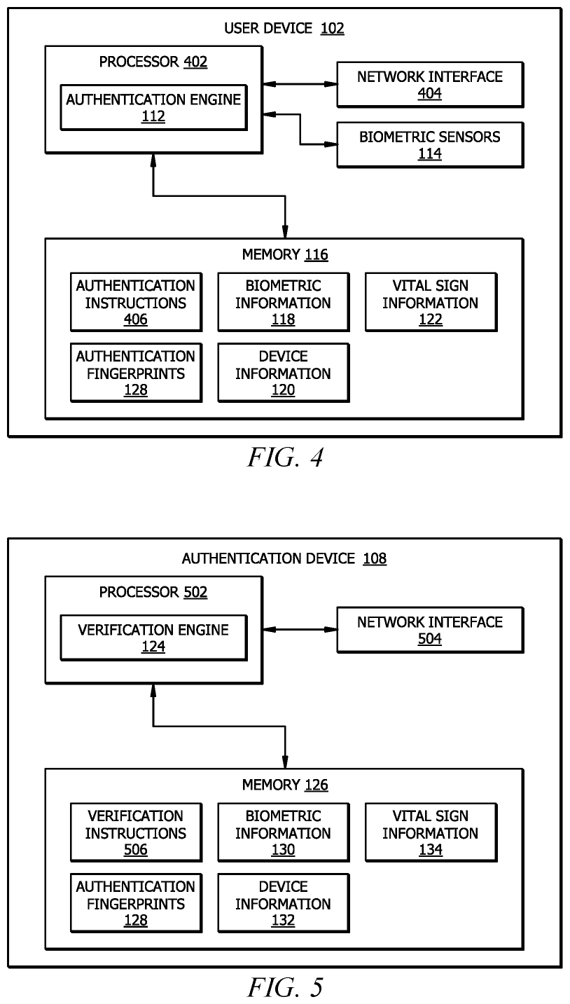

In one embodiment, the user device 102 comprises an authentication engine 112, one or more biometric sensors 114, and a memory 116. The user device 102 may further comprise a graphical user interface, a display, a touch screen, buttons, knobs, or any other suitable combination of components. Additional details about the hardware configuration of the user device 102 are described in FIG. 4.

The memory 116 is configured to store biometric information 118, device information 120, vital sign information 122, and/or any other suitable type of data. The biometric information 118 comprises information that identifies a physical characteristics of a user. For example, the biometric information 118 may be a signal (e.g. a binary bit string) that is uniquely linked to a user based on the physical characteristics of the user. In other examples, the biometric signal may use any other suitable type of format to represent a user's physical characteristics. The device information 120 comprises information that identifies the user device 102 that is associated with the user. Examples of device information 120 include, but are not limited to, a phone number, a Media Access Control (MAC) address, an Internet Protocol (IP) address, or any other suitable device identifier. The vital sign information 122 comprises information that identifies a physical state of the user. For example, the vital sign information 122 may comprise information that is associated with the current state of the heart and/or lungs of the user. Examples of the vital sign information 122 include, but are not limited to, a respiration rate, a pulse rate, a blood pressure measurement, a body temperature measurement, or any other suitable type of information that is associated with the current physical state of the user.

In FIG. 1, a biometric sensor 114 is shown as being integrated with the user device 102. In some embodiments, a biometric sensor 114 may be an external device that is in signal communication with the user device 102. Examples of biometric sensors 114 include, but are not limited to, retina scanners, fingerprint scanners, a temperature sensor, a blood pressure monitor, a heart rate monitor, an oxygen sensor, or any other suitable type of biometric device. A biometric sensor 114 is a device that is configured to capture information about a person's physical characteristics and to output a biometric signal based on captured information. As an example, a biometric sensor 114 may be configured to perform a retinal scan of the user's eye and to generate a biometric signal for the user based on the retinal scan. As another example, a biometric sensor 114 is configured to perform a fingerprint scan of the user's finger and to generate a biometric signal for the user based on the fingerprint scan.

The authentication engine 112 is generally configured to capture biometric information 118 and device information 120 and to generate an authentication fingerprint 128 based on the biometric information 118 and the device information 120. This process allows the authentication engine 112 to generate an authentication fingerprint 128 that can be used as a static authentication token to authenticate a user based on the unique combination of their physical characteristics and their user device. Since the authentication fingerprint 128 is a known static authentication token, the authentication engine 112 can provide the authentication fingerprint 128 to the authentication device 108 to authenticate a user's identity.

The authentication engine 112 is further configured to obtain vital sign information 122 for the user and to generate an authentication request 136 for authenticating the user based on the vital sign information 122 and the authentication fingerprint 128. The vital sign information 122 is a dynamic authentication token that can be used to authenticate a user based on the current physical state of the user. For example, the vital sign information 122 may comprise information about the breathing rate or heart rate of the user when making an authentication request 136. The authentication device 108 may compare the vital sign information 122 to previously stored vital sign information 134 for the user to determine whether the user is under duress when sending an authentication request 136. This process provides information security by denying an authentication request 136 when the user is under duress even if the user provides valid authentication credentials. An example of the authentication engine 112 in operation is described in FIG. 2.

### Network Device

Examples of the network device 104 include, but are not limited to, a server, a computer, a database, a point-of-sale (POS) device, a card reader, an automated teller machine (ATM), or any other suitable type of device. The network device 104 may be associated with a business that provides services or products to users. For example, the network device 104 may be POS device in a store where a user is shopping. As another example, the network device 104 may be an ATM that a user is interacting with. As another example, the network device 104 may be a server or database that is configured to provide online services (e.g. streaming services or data storage) to a user. The network device 104 is generally configured to route an authentication request 136 from a user to the authentication device 108 to authenticate the user. In response to sending the authentication request 136 to the authentication device 108, the network device 104 receives an authentication response 138 from the authentication device 108 that indicates whether the user has passed authentication. The network device 104 is further configured to allow the user to access products or services in response to determining that the user has passed authentication.

### Service Processor Device

Examples of the service processor device 106 include, but are not limited to, a server, a computer, or any other suitable type of network device. The service processor device 106 may be associated with an enterprise or a third-party such as a financial institute, banking facilities, or a credit card company. In one embodiment, the service processor device 106 is configured to facilitate a transaction for a service or a purchase for a user. For example, the service processor device 106 may comprise hardware configured to route an authentication request 136 to the authentication device 108 to authenticate a user. In response to sending the authentication request 136 to the authentication device 108, the service processor device 106 receives an authentication response 138 from the authentication device 108 and sends the authentication response 138 to the network device 104. The service processor device 106 may be further configured to provide a service or to facilitate a transaction for the user in response to determining that the user has passed authentication based on the authentication response 138 from the authentication device 108. In some embodiments, the service processor device 106 may be optional and omitted. In this case, the network device 104 is configured to bypass the service processor device 106 to communicate with the authentication device 108.

### Authentication Device

Examples of the authentication device 108 include, but are not limited to, a server, a database, a computer, or any other suitable type of device. The authentication device 108 is generally configured to authenticate a user before allowing the user to perform a restricted operation such as downloading data, uploading data, transmitting information, accessing information, or performing a transaction. As an example, an authentication device 108 may be integrated with a database that is configured to store information. In this example, the authentication device 108 is configured to authenticate a user before allowing the user to access the information in the database. As another example, an authentication device 108 may be integrated with a cloud server that is configured to provide a service to a user. In this example, the authentication device 108 is configured to authenticate the user before allowing the user to access the service. As another example, the authentication device 108 may be configured to work cooperatively with financial transaction devices (e.g. network device 104 and service processor device 106). In this example, the authentication device 108 is configured to authenticate a user before allowing the user to complete a financial transaction. In other examples, the authentication device 108 may be integrated with any other suitable type of device.

In one embodiment, the authentication device 108 comprises a verification engine 124, and a memory 126. Additional details about the hardware configuration of the authentication device 108 are described in FIG. 5. The memory 126 is configured to store authentication fingerprints 128, biometric information 130, device information 132, vital sign information 134, and/or any other suitable type of data. The authentication fingerprints 128, the biometric information 130, the device information 132, and the vital sign information 134 are configured similar to the authentication fingerprints 128, the biometric information 118, the device information 120, and the vital sign information 122 described above, respectively.

The verification engine 124 is generally configured to authenticate a user based on the authentication fingerprint 128 and vital sign information 122 that is provided in an authentication request 136. The verification engine 124 is further configured to output an authentication response 138 that indicates whether the user has passed authentication based on the information provided in the authentication request 136. The verification engine 124 is further configured to trigger fraud protection services for the user in response to determining that the user has failed authentication based on the information provided in the authentication request 136. Triggering fraud protection provides information security for a user by blocking any transactions or data transfer from the user's user device 102. An example of the verification engine 124 in operation is described in FIG. 4.

### Authentication Process for a User Device

FIG. 2 is a flowchart of an embodiment of an authentication process 200 for a user device 102 using behavior-based authentication. The authentication system 100 may employ process 200 to authenticate a user using a static authentication token (i.e. an authentication fingerprint 128) and a dynamic authentication token (i.e. vital sign information 122) before allowing the user to transmit or receive data from a network device 104. As an example, the network device 104 may be a POS device. In this example, the user device 102 may employ process 200 to authenticate a user before transmitting data for making a transaction to the network device 104. As another example, the network device 104 may be a database. In this example, the user device 102 may employ process 200 to authenticate a user before uploading data or downloading data from the network device 104. As another example, the network device 104 may be a server that is configured to provide services to the user. In this example, the user device 102 may employ process 200 to authenticate the user before accessing the services from the network device 104. In other examples, the user device 102 may employ process 200 to authenticate a user before transmitting or receiving any other suitable type of data from the network device 104.

At step 202, the user device 102 captures biometric information 118 for a user. The user device 102 may employ one or more biometric sensors 114 to capture biometric information 118 for the user. As an example, a biometric sensor 114 may be configured to perform a retinal scan of the user's eye and to generate biometric information 118 for the user based on the retinal scan. As another example, a biometric sensor 114 is configured to perform a fingerprint scan of the user's finger and to generate biometric information 118 for the user based on the fingerprint scan. In other examples, the user device 102 may employ any other suitable type of biometric sensor 114 to capture biometric information for the user.

At step 204, the user device 102 captures device information 120 for the user device 102 that is associated with the user. Here, the user device 102 obtains device information 120 that uniquely identifies the user device 102. The user device 102 may obtain a phone number, a MAC address, an IP address, email address, or any other suitable device identifier for the user device 102. In some embodiments, the device information 120 may further comprise location information that identifies where the user device 102 is currently located and/or any other suitable type of information that is associated with the user device 102.

At step 206, the user device 102 generates an authentication fingerprint 128 based on the biometric information 118 and the device information 120. In one embodiment, the user device 102 generates an authentication fingerprint 128 by performing a hashing operation on the biometric information 118 and the device information 120. In this example, the hashing operation obfuscates the biometric information 118 and the device information 120 to generate the authentication fingerprint 128. This process provides information security by masking the biometric information 118 and the device information 120 in case the authentication fingerprint 128 is obtained by a bad actor. In other embodiments, the user device 102 may generate an authentication fingerprint 128 by applying an encryption algorithm to the biometric information 118 and the device information 120. The user device 102 may employ any suitable type of hashing or encrypting operation on the biometric information 118 and the device information 120 to generate the authentication fingerprint 128.

At step 208, the user device 102 obtains vital sign information 122 for the user. Here, the user device 102 employs one or more biometric sensors 114 to capture vital sign information 122 for the user. As an example, the user device 102 may employ a blood pressure monitor to capture the user's blood pressure. As another example, the user device 102 may employ a temperature sensor to capture the user's body temperature. As another example, the user device 102 may employ a heart rate monitor to capture the user's pulse rate. As another example, the user device 102 may employ an oxygen sensor to capture the user's breathing rate or oxygen levels. In other examples, the user device 102 may employ any other suitable type of biometric sensor 114 to capture information about the user's current physical state.

At step 210, the user device 102 generates an authentication request 136 for the user that comprises the authentication fingerprint 128 and the vital sign information 122. The user device 102 may combine the authentication fingerprint 128 and the vital sign information 122 into any suitable type of data structure or message format to generate the authentication request 136. In some embodiments, the authentication request 136 may further comprise a user identifier (e.g. a user name or account number), authentication credentials for the user (e.g. a passcode or a password), or any other suitable type of information. At step 212, the user device 102 sends the authentication request 136 to the network device 104.

After sending the authentication request 136 to the network device 104, the user device 102 waits until it receives an authentication response 138 from the network device 104. The authentication response 138 indicates whether the user has been authenticated based on the authentication fingerprint 128 and the vital sign information 122 that was provided in the authentication request 136. The authentication response 138 may comprise a message, a flag, or any other suitable type of indicator that indicates whether the user has passed authentication.

At step 214, the user device 102 determines whether the authentication was approved based on the authentication response 138. The user device 102 proceeds to step 216 in response to determining that the user has not passed authentication. In this case, the user device 102 will implement fraud protection services to protect the user and their data.

At step 216, the user device 102 triggers fraud protection services for the user. As an example, triggering fraud protection services for the user may comprise prohibiting or blocking a data transfer for the user. In this example, the user device 102 may adjust network or device settings in the user device 102 to restrict the user's ability to transmit or receive data from the network device 104. As another example, triggering fraud protection services for the user may comprise sending an alert to the user device 102 that is associated with the user. In this example, the user device 102 may receive a notification about suspicious activity on the user's account. The notification may be a pop-up notification, a text message, an email, or any other suitable type of notification. As another example, triggering fraud protection services for the user may comprise sending a request for an authorization code from the user. In this example, the user device 102 may prompt the user to provide an authorization code to confirm the user's identify. The authorization code may be a user-defined code, a temporary token that is sent to the user, or any other suitable type of authorization code. In other examples, triggering fraud protection services may comprise any other suitable type of action that protects the user's account and data.

Returning to step 214, the user device 102 proceeds to step 218 in response to determining that the authentication was approved. In this case, the user device 102 determines that the user has passed authentication and that the user device 102 is authorized to begin transmitting data to the network device 104.

At step 218, the user device 102 transmits data from the user device 102 to the network device 104. For example, when the network device 104 is a POS device, the user device 102 may send data for conducting a transaction to the network device 104. As another example, when the network device 104 is a database, the user device 102 may upload data or download data from the network device 104. As another example, when the network device 104 is a server that is configured to provide services to the user, the user device 102 may upload data or download data from the network device 104. In other examples, the user device 102 may transmit or receive any other suitable type of data from the network device 104.

### Authentication Process for an Authentication Device

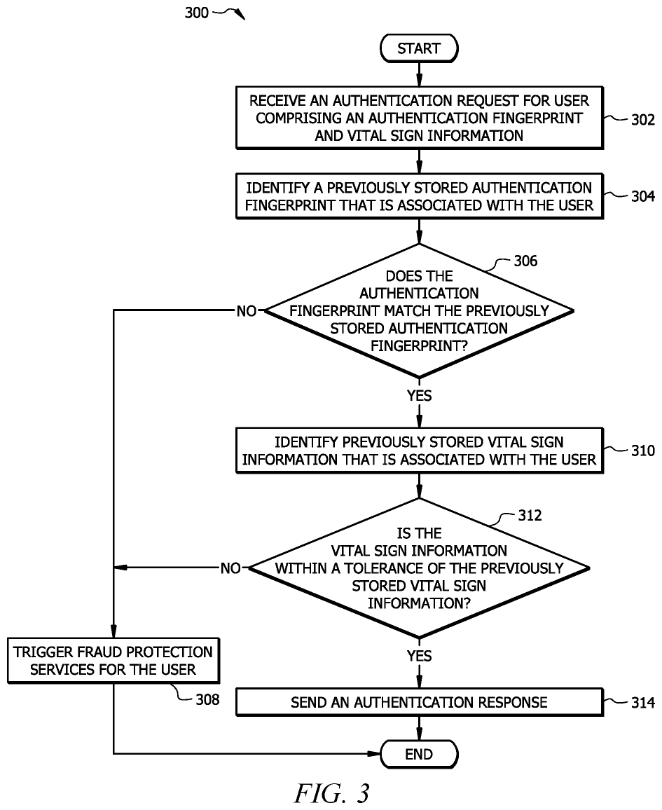

FIG. 3 is a flowchart of an embodiment of an authentication process 300 for an authentication device 108 using behavior-based authentication. The authentication system 100 may employ process 300 to authenticate a user based on a static authentication token (i.e. an authentication fingerprint 128) and a dynamic authentication token (i.e. vital sign information 122) before allowing the user to transmit or receive data from a network device 104.

At step 302, the authentication device 108 receives an authentication request 136 for a user. The authentication request 136 comprises an authentication fingerprint 128 and vital sign information 122. For example, the authentication request 136 may be sent to the authentication device 108 via the network device 104 and the service processor device 106 to authenticate a user before allowing the user to exchange data with the network device 104. In this example, the authentication request 136 may be generated and sent by a user device 102 using a process similar to process 200 that is described in FIG. 2.

At step 304, the authentication device 108 identifies a previously-stored authentication fingerprint 128 that is associated with the user. Here, the authentication device 108 compares the received authentication fingerprint 128 with the authentication fingerprints 128 that are stored in memory 126 to determine whether the received authentication fingerprint 128 matches any of the previously stored authentication fingerprints 128. In some embodiments, the authentication device 108 applies a hashing or decryption operation on the received authentication fingerprint 128 to deobfuscate the authentication fingerprint 128 before comparing the received authentication fingerprint 128 to the authentication fingerprints 128 that are stored in memory 126.

At step 306, the authentication device 108 determines whether the received authentication fingerprint 128 matches a previously stored authentication fingerprint 128 for the user. The authentication device 108 proceeds to step 308 in response to determining that the received authentication fingerprint 128 does not match the previously stored authentication fingerprint 128. In this case, the authentication device 108 determines that the combination of the biometric information 118 and the device information 120 that was used to generate the authentication fingerprint 128 does not match the authentication fingerprint 128 that is stored in memory 126. This may indicate that a bad actor has provided the wrong biometric information 118 and/or device information 120 when generating the authentication fingerprint 128. In this case, the authentication device 108 will implement fraud protection services to protect the user and their data.

At step 308, the authentication device 108 triggers fraud protection services for the user. As an example, triggering fraud protection services for the user may comprise prohibiting or blocking a data transfer for the user. In this example, the authentication device 108 may send instructions to the network device 104 and/or service processor device 106 to restrict or block data transfers with the user device 102. As another example, triggering fraud protection services for the user may comprise sending an alert to the user device 102 that is associated with the user. In this example, the authentication device 108 may send an alert message to the user device 102 that indicates that suspicious activity has been detected with the user's account. As another example, triggering fraud protection services for the user may comprise sending a request for an authorization code to the user device 102 that is associated with the user. In this example, the authentication device 108 sends a request for the user to provide an authorization code to confirm the user's identity. The authorization code may be a user-defined code, a temporary token that is sent to the user, or any other suitable type of authorization code. In other examples, triggering fraud protection services may comprise any other suitable type of action that protects the user's account and data.

Returning to step 306, the authentication device 108 proceeds to step 310 in response to determining that the received authentication fingerprint 128 matches the previously stored authentication fingerprint 128. In this case, the authentication device 108 determines that the correct biometric information 118 and device information 120 was provided by the user to generate the authentication fingerprint 128. This means that the user has passed the first phase of authentication based on the static authentication token (i.e. the authentication fingerprint 128). The authentication device 108 then proceeds to determine whether the user passes the second phase of authentication based on the dynamic authentication token (i.e. the vital sign information 122).

At step 310, the authentication device 108 identifies previously stored vital sign information 134 that is associated with the user. For example, the authentication device 108 may identify vital sign information 134 that is linked with the authentication fingerprint 128 for the user. The vital sign information 134 may comprise information associated with the user's heart rate, blood pressure, breathing rate, oxygen levels, or any other suitable type of information that is associated with a physical state of the user.

At step 312, the authentication device 108 determines whether the received vital sign information 122 matches the previously stored vital sign information 134. In one embodiment, the authentication device 108 first determines a tolerance threshold value for the vital sign information 134. The tolerance threshold value identifies a maximum difference or deviation from the previously stored vital sign information 134 that is acceptable to pass authentication. For example, the tolerance threshold value may be set to a plus or minus five percent difference from the previously stored vital sign information 134. For instance, the vital sign information 134 may indicate that the user has a resting heart rate of 70 beats per minute (bpm). In this example, the authentication device 108 determines that the tolerance threshold value corresponds with a minimum of 66.5 bpm and a maximum of 73.5 bpm. In other examples, the tolerance threshold value may be set to two percent, three percent, ten percent, or any other suitable value. After determining the tolerance threshold value, the authentication device 108 compares the received vital sign information 122 to the tolerance threshold value. Continuing with the previous example, the authentication device 108 determines that the received vital sign information 122 matches the previously stored vital sign information 134 when the user's heart rate is between 66.5 bpm and 73.5 bpm. Otherwise, the authentication device 108 determines that the received vital sign information 122 does not match the previously stored vital sign information 134 when the user's heart rate is less than 66.5 bpm or greater than 73.5 bpm. The authentication device 108 may repeat this process for any other vital sign metrics within the received vital sign information 122.

The authentication device 108 proceeds to step 308 in response to determining that the vital sign information 122 does not match the previously stored vital sign information 134. In this case, the authentication device 108 determines that the user's current physical state is abnormal. This may indicate that the user is making an authentication request while under duress. In response to determining that the vital sign information 122 does not match the previously stored vital sign information 134, the authentication device 108 will implement fraud protection services to protect the user and their data.

Otherwise, the authentication device 108 proceeds to step 314 in response to determining that the received vital sign information 122 matches the previously stored vital sign information 134. In this case, the authentication device 108 determines that the user has passed the second phase of authentication based on the dynamic static token (i.e. the vital sign information 122.

At step 314, the authentication device 108 sends an authentication response 138. After successfully passing both phases of authentication, the authentication device 108 generates an authentication response 138 that indicates that the user has successfully passed authentication. The authentication device 108 sends the authentication response 138 to the user device 102 via the service processor device 106 and the network device 104.

### Hardware Configuration for a User Device

FIG. 4 is an embodiment of a user device 102 of an authentication system 100. As an example, the user device 102 comprises a processor 402, a memory 116, biometric sensors 114, and a network interface 404. The user device 102 may be configured as shown or in any other suitable configuration.

### Processor

The processor 402 comprises one or more processors operably coupled to the memory 116. The processor 402 is any electronic circuitry including, but not limited to, state machines, one or more central processing unit (CPU) chips, logic units, cores (e.g. a multi-core processor), field-programmable gate array (FPGAs), application-specific integrated circuits (ASICs), or digital signal processors (DSPs). The processor 402 may be a programmable logic device, a microcontroller, a microprocessor, or any suitable combination of the preceding. The processor 402 is communicatively coupled to and in signal communication with the memory 116, the biometric sensors 114, and the network interface 404. The one or more processors are configured to process data and may be implemented in hardware or software. For example, the processor 402 may be 8-bit, 16-bit, 32-bit, 64-bit, or of any other suitable architecture. The processor 402 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute authentication instructions 406 to implement the authentication engine 112. In this way, processor 402 may be a special-purpose computer designed to implement the functions disclosed herein. In an embodiment, the authentication engine 112 is implemented using logic units, FPGAs, ASICs, DSPs, or any other suitable hardware. The authentication engine 112 is configured to operate as described in FIGS. 1 and 2. For example, the authentication engine 112 may be configured to perform the steps of process 200 as described in FIG. 2.

### Memory

The memory 116 is operable to store any of the information described above with respect to FIGS. 1 and 2 along with any other data, instructions, logic, rules, or code operable to implement the function(s) described herein when executed by the processor 402. The memory 116 comprises one or more disks, tape drives, or solid-state drives, and may be used as an over-flow data storage device, to store programs when such programs are selected for execution, and to store instructions and data that are read during program execution. The memory 116 may be volatile or non-volatile and may comprise a read-only memory (ROM), random-access memory (RAM), ternary content-addressable memory (TCAM), dynamic random-access memory (DRAM), and static random-access memory (SRAM).

The memory 116 is operable to store authentication instructions 406, authentication fingerprints 128, biometric information 118, device information 120, vital sign information 122, and/or any other data or instructions. The authentication instructions 406 may comprise any suitable set of instructions, logic, rules, or code operable to execute the authentication engine 112. The authentication fingerprints 128, the biometric information 118, the device information 120, and the vital sign information 122 are configured similar to the authentication fingerprints 128, the biometric information 118, the device information 120, and the vital sign information 122 described in FIGS. 1-3, respectively.

### Biometric Sensors

Examples of biometric sensors 114 include, but are not limited to, retina scanners and fingerprint scanners. Biometric sensors 114 may be configured similar to the biometric sensors 114 that are described in FIG. 1. For example, a biometric sensor 114 may be configured to capture information about a person's physical characteristics and to output a biometric signal based on captured information. As an example, a biometric sensor 114 may be configured to perform a retinal scan of the user's eye and to generate a biometric signal for the user based on the retinal scan. As another example, a biometric sensor 114 is configured to perform a fingerprint scan of the user's finger and to generate a biometric signal for the user based on the fingerprint scan. The biometric signal is used by the authentication engine 112 to generate biometric information 118 and an authentication fingerprint 128 that can be used to identify and authenticate a user.

### Network Interface

The network interface 404 is configured to enable wired and/or wireless communications. The network interface 404 is configured to communicate data between the network device 104, the service processor device 106, the authentication device 108, and other devices, systems, or domains. For example, the network interface 404 may comprise a near-field communication (NFC) interface, a Bluetooth interface, a Zigbee interface, a Z-wave interface, a radio-frequency identification (RFID) interface, a WIFI interface, a LAN interface, a WAN interface, a PAN interface, a modem, a switch, or a router. The processor 402 is configured to send and receive data using the network interface 404. The network interface 404 may be configured to use any suitable type of communication protocol as would be appreciated by one of ordinary skill in the art.

### Hardware Configuration for an Authentication Device

FIG. 5 is an embodiment of an authentication device 108 of an authentication system 100. As an example, the authentication device 108 comprises a processor 502, a memory 126, and a network interface 504. The authentication device 108 may be configured as shown or in any other suitable configuration.

### Processor

The processor 502 comprises one or more processors operably coupled to the memory 126. The processor 502 is any electronic circuitry including, but not limited to, state machines, one or more CPU chips, logic units, cores (e.g. a multi-core processor), FPGAs, ASICs, or DSPs. The processor 502 may be a programmable logic device, a microcontroller, a microprocessor, or any suitable combination of the preceding. The processor 502 is communicatively coupled to and in signal communication with the memory 126 and the network interface 504. The one or more processors are configured to process data and may be implemented in hardware or software. For example, the processor 502 may be 8-bit, 16-bit, 32-bit, 64-bit, or of any other suitable architecture. The processor 502 may include an ALU for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute verification instructions 506 to implement the verification engine 124. In this way, processor 502 may be a special-purpose computer designed to implement the functions disclosed herein. In an embodiment, the verification engine 124 is implemented using logic units, FPGAs, ASICs, DSPs, or any other suitable hardware. The verification engine 124 is configured to operate as described in FIGS. 1 and 3. For example, the verification engine 124 may be configured to perform the steps of process 300 as described in FIG. 3.

### Memory

The memory 126 is operable to store any of the information described above with respect to FIGS. 1 and 3 along with any other data, instructions, logic, rules, or code operable to implement the function(s) described herein when executed by the processor 502. The memory 126 comprises one or more disks, tape drives, or solid-state drives, and may be used as an over-flow data storage device, to store programs when such programs are selected for execution, and to store instructions and data that are read during program execution. The memory 126 may be volatile or non-volatile and may comprise a ROM, RAM, TCAM, DRAM, and SRAM.

The memory 126 is operable to store verification instructions 506, authentication fingerprints 128, biometric information 118, device information 120, vital sign information 122, and/or any other data or instructions. The verification instructions 506 may comprise any suitable set of instructions, logic, rules, or code operable to execute the verification engine 124. The authentication fingerprints 128, the biometric information 118, the device information 120, and the vital sign information 122 are configured similar to the authentication fingerprints 128, the biometric information 118, the device information 120, and the vital sign information 122 described in FIGS. 1-3, respectively.

### Network Interface

The network interface 504 is configured to enable wired and/or wireless communications. The network interface 504 is configured to communicate data between the user device 102, the network device 104, the service processor device 106, and other devices, systems, or domains. For example, the network interface 504 may comprise an NFC interface, a Bluetooth interface, a Zigbee interface, a Z-wave interface, an RFID interface, a WIFI interface, a LAN interface, a WAN interface, a PAN interface, a modem, a switch, or a router. The processor 502 is configured to send and receive data using the network interface 504. The network interface 504 may be configured to use any suitable type of communication protocol as would be appreciated by one of ordinary skill in the art.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A device, comprising:
a first biometric sensor configured to capture biometric information that identifies physical characteristics of a user;
a second biometric sensor configured to capture vital sign information that identifies a physical state of the user; and
a processor operably coupled to the first biometric sensor and the second sensor, and configured to:
capture biometric information for the user using the first biometric sensor;
capture device information for a user device that is associated with the user;
generate an authentication fingerprint for the user based on the biometric information and the device information, wherein the authentication fingerprint comprises a unique binary bit string that is generated based on a combination of the biometric information and the device information;
obtain vital sign information using the second biometric sensor;
generate an authentication request that comprises the authentication fingerprint and the vital sign information; and
send the authentication request to a network device.

2. The device of claim 1, wherein the processor is further configured to:
receive an authentication approval from the network device; and
send data to the network device in response to receiving the authentication approval.

3. The device of claim 1, wherein generating the authentication fingerprint comprises obfuscating the biometric information and the device information by performing a hashing operation on the biometric information and the device information.

4. The device of claim 1, wherein the device information comprises location information for the user device.

5. The device of claim 1, wherein the biometric information comprises information associated with a fingerprint for the user.

6. The device of claim 1, wherein:
the processor is further configured to receive authentication credentials for the user; and
the authentication request comprises the authentication credentials.

7. The device of claim 1, wherein the vital sign information comprises
information associated with a heart rate for the user.

8. An authentication method, comprising:
capturing biometric information for a user using a first biometric sensor, wherein the first biometric sensor is configured to capture biometric information that identifies physical characteristics of the user;
capturing device information for a user device that is associated with the user;
generating an authentication fingerprint for the user based on the biometric information and the device information, wherein the authentication fingerprint comprises a unique binary bit string that is generated based on a combination of the biometric information and the device information;
obtaining vital sign information using a second biometric sensor, wherein the second biometric sensor is configured to capture vital sign information that identifies a physical state of the user;
generating an authentication request that comprises the authentication fingerprint and the vital sign information; and
sending the authentication request to a network device.

9. The method of claim 8, further comprising:
receiving an authentication approval from the network device; and
sending data to the network device in response to receiving the authentication approval.

10. The method of claim 8, wherein generating the authentication fingerprint comprises obfuscating the biometric information and the device information by performing a hashing operation on the biometric information and the device information.

11. The method of claim 8, wherein the device information comprises location information for the user device.

12. The method of claim 8, wherein the biometric information comprises information associated with a fingerprint for the user.

13. The method of claim 8, further comprising receiving authentication credentials for the user; and
wherein the authentication request comprises the authentication credentials.

14. The method of claim 8, wherein the vital sign information comprises information associated with a heart rate for the user.

15. A computer program product comprising executable instructions stored in a non-transitory computer-readable medium that when executed by a processor causes the processor to:
capture biometric information for a user using a first biometric sensor, wherein the first biometric sensor is configured to capture biometric information that identifies physical characteristics of the user;
capture device information for a user device that is associated with the user;
generate an authentication fingerprint for the user based on the biometric information and the device information, wherein the authentication fingerprint comprises a unique binary bit string that is generated based on a combination of the biometric information and the device information;
obtain vital sign information using a second biometric sensor, wherein the second biometric sensor is configured to capture vital sign information that identifies a physical state of the user;
generate an authentication request that comprises the authentication fingerprint and the vital sign information; and
send the authentication request to a network device.

16. The computer program product of claim 15, further comprising instructions that when executed by the processor causes the processor to:
receive an authentication approval from the network device; and
send data to the network device in response to receiving the authentication approval.

17. The computer program product of claim 15, wherein generating the authentication fingerprint comprises obfuscating the biometric information and the device information by performing a hashing operation on the biometric information and the device information.

18. The computer program product of claim 15, wherein the biometric information comprises information associated with a fingerprint for the user.

19. The computer program product of claim 15, further comprising instructions that when executed by the processor causes the processor to receive authentication credentials for the user; and
wherein the authentication request comprises the authentication credentials.

20. The computer program product of claim 15, wherein the vital sign information comprises information associated with a heart rate for the user.
